(19) United States
(12) Patent Application Publication
(10) Pub. No.: US 2012/0296837 A1
(43) Pub. Date: Nov. 22, 2012

(54) SYSTEM, METHOD, AND COMPUTER READABLE MEDIUM FOR PROVIDING AUTOMATED DISSEMINATION OF ADVERTISING THROUGH SEARCH ENGINES, WEBSITES, AND ONLINE SOCIAL NETWORKING SITES

(76) Inventor: Brian Smith, Sparks, MD (US)

(21) Appl. No.: 13/111,463

(22) Filed: May 19, 2011

(51) Int. Cl. G06Q 10/00; G06F 15/16

(52) U.S. Cl. 705/319; 709/206; 705/1.1

(57) ABSTRACT

Aspects of the invention may involve systems, methods, and computer readable medium. In an embodiment of the invention, a computer-implemented method for disseminating information may be provided that may include receiving parent data, child data, and/or content data by a computer system. The parent data and content data may be received from a parent computer system. The child data may be received from a child computer system. The child data may contain child contact information and child distribution information. The computer system may create a web resource using, for example, content data. The computer system may insert child contact information into the web resource. The web resource may be transmitted to one or more online social networking websites based on the child distribution information.

### BACKGROUND

Current business advertising tools may send targeted information, such as emails, to a pre-selected group of entities or contacts. Advertising tools such as email marketing software and other online marketing vehicles may be utilized to send emails from an entity to that entity's contacts.

### SUMMARY

Aspects of the invention may involve systems, methods, and computer readable medium. In an embodiment of the invention, a computer-implemented method for disseminating information may be provided that may include receiving parent data, child data, and/or content data by a computer system. The parent data and content data may be retrieved from a parent computer system. The child data may be retrieved from a child computer system. The parent data may contain parent contact information and the child data may contain child contact information and child distribution information. The computer system may create a web resource using content data and/or parent data. The computer system may insert child contact information into the web resource. The web resource may be transmitted to one or more online social networking websites based on the child distribution information.

In another embodiment, a computer-implemented method for disseminating information may be provided that may include accessing previously stored parent business data, content data, child business data, and/or one or more dissemination targets. The dissemination targets may be received from a plurality of children. A computer may create a web resource, where the web resource may be based on content data and parent business data. Dissemination approval may be received and parent business data in the web resource may be replaced with child business data. The web resource may be transmitted to one or more dissemination targets.

In another embodiment, a tangible non-transitory computer-readable storage media for storing computer-executable instructions executable by processing logic may be provided, where the media storing one or more instructions may include receiving parent data. The parent data may include content data and parent business information. An initial webpage may be created using the parent data. The initial webpage may be transmitted to a child. The child may approve the initial webpage. A second webpage may be created and may be transmitted to a child distribution list.

In yet another embodiment, a computer-implemented system for distributing advertisements may be provided that may include a storage device for storing parent business information and child business information. The system may also include a processor. The processor may be configured to collect parent webpage content information; create a first webpage based on the parent webpage content information and stored parent business information; transmit the first webpage to a child; process a selection from the child; create a second webpage in response to the selection from the child, where the second webpage may be created based on the first webpage and stored child business information; and distribute the second webpage to a contact.

### BRIEF DESCRIPTION OF THE DRAWINGS

The foregoing and other features and advantages of the invention will be apparent from the following, more particular description of various exemplary embodiments, as illustrated in the accompanying drawings wherein like reference numbers generally indicate identical, functionally similar, and/or structurally similar elements. The first digits in the reference number indicate the drawing in which an element first appears.

FIG. 1 depicts an illustrative high-level device processing system for use with an illustrative embodiment for providing resource dissemination;

FIG. 2 depicts an illustrative distribution system for use with an illustrative embodiment for providing resource dissemination;

FIG. 3 illustrates an example distribution flowchart describing processing performed in an illustrative embodiment;

FIG. 4 illustrates an example screenshot of a webpage containing parent information in an illustrative embodiment;

FIG. 5 illustrates an example screenshot of a webpage containing child information in an illustrative embodiment;

FIG. 6 illustrates an example screenshot of a reduced webpage containing reduced parent information in an illustrative embodiment;

FIG. 7 illustrates an example screenshot of a reduced webpage containing reduced child information in an illustrative embodiment;

FIG. 8 illustrates an example screenshot of a parent dashboard in an illustrative embodiment;

FIG. 9 illustrates an example screenshot of a child dashboard in an illustrative embodiment;

FIG. 10 illustrates an example take action screenshot in an illustrative embodiment;

FIG. 11 depicts example flowcharts describing processing performed in an illustrative embodiment;

FIG. 12 depicts example high-level software modules for use with an illustrative embodiment for providing resource dissemination; and

FIG. 13 depicts an example computer system that may be used in implementing an illustrative embodiment of the present invention.

### DESCRIPTION OF THE EMBODIMENTS

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. A person skilled in the relevant art will recognize that other components and configurations may be used without departing from the spirit and scope of the embodiments. It is to be understood that each specific element includes all technical equivalents that operate in a similar manner to accomplish a similar purpose. The examples and embodiments described herein are non-limiting examples.

All publications cited herein are hereby incorporated by reference in their entirety.

As used herein, the term “a” refers to one or more. The terms “including,” “for example,” “such as,” “e.g.,” “may be” and the like, are meant to include, but not be limited to, the listed examples. The term “product” may refer to both products and services.

### Overview

In an embodiment, news, articles, announcements, brochures, sales sheets, videos, and/or text documents may be distributed to online channels and platforms through a data communications network (e.g., internet). The online channels and platforms may include, but are not limited to, social media sites, social networks, email contacts, search engines, websites, blogs, etc. The distribution may occur through a parent and child relationship, for example. The parent may develop media content and the media content may be distributed through the child's contact list. An example developed using a social online marketing network may be BragForce, which may be the BizBrag.com platform.

The parent and child relationship may occur when, for example, a company sends content to another company. The sending company may be the parent and the receiving company may be the child. Parent-child examples may be as follows, and may be reciprocal, as the parent may be the entity creating and triggering the content distribution cycle: manufacturer-distributor, manufacturer-retailer, distributor-retailer, plumber-electrician, realtor-lender, franchisor-franchisee, enterprise-customer, service provider-service provider.

An embodiment of the invention may leverage and utilize network connections (e.g., the child's connections) as an opt-in conduit and/or facilitator to distribute content and yet may maintain multiple degrees of separation throughout various online channels.

The process may occur from a single platform that may enable parent and child to connect (e.g., communicate) to each other. This connection may enable parent content to reach child connections, child content to reach parent connections, or a combination of parent and child content to reach parent and/or child contacts. Reaching connections may occur through several online channels such as, social media sites, social networks, email contacts, search engines, websites, blogs, etc.

For example, parent and child may sign up to become members of BizBrag.com. Once they are members, parent and child may connect to each other through BizBrag's social online marketing network (e.g., the BragForce). Once parent and child are connected through the BragForce, content may be sent from parent to child and vise-versa allowing for content to flow through the parent and child to their respective connections and contacts, achieving multiple degrees of separation.

In one embodiment, a parent and child may connect through an embodiment of the invention to facilitate the parent to create and/or send content to the child. Content may be in the form of, for example, an article, announcement, webpage, video, brochure, image, coupon, sales sheet, text document or another type of media. The child may pass along the content to the child's various online marketing channels and networks. Thus, the parent's content may reach the child's connections, contacts and customers. To the receiver of the content, the content may appear to be generated and distributed by the child. The channels may include, but are not limited to social networks, social media, email contacts, blogs, video sites, search engines, online news feeds, etc.

In addition to content, the parent may send to the child, parent information such as name, address, email, website or website address, a postal address, a telephone number, a map location, blog, store address, store website, social network links, social media links, logo, email capture components, news, reviews, past information, etc. Content from the parent may be automatically forwarded to the child's channels by, for example, clicking an ‘auto-forward’ button.

In another embodiment, the parent content may be manually forwarded to the child's channels. The manual forward may require action on the part of the child to forward the parent's content to the child's channels.

In an embodiment, prior to sending parent content to child contacts, parent information contained in the content may be replaced with child information. Such a replacement may occur automatically or through manual intervention. When parent sends content through the child to child network connections, the contact information may either remain the parent's contact information or change to the child's contact information. Replacing parent information with child information may allow for branding to the child's own network, while utilizing the parent's content. Alternatively, the parent's contact information may remain with the content throughout the process, so when the content is disseminated via the child's network, the parent's contact information is shown to customers, potential customers, and/or clients.

### Illustrative Systems

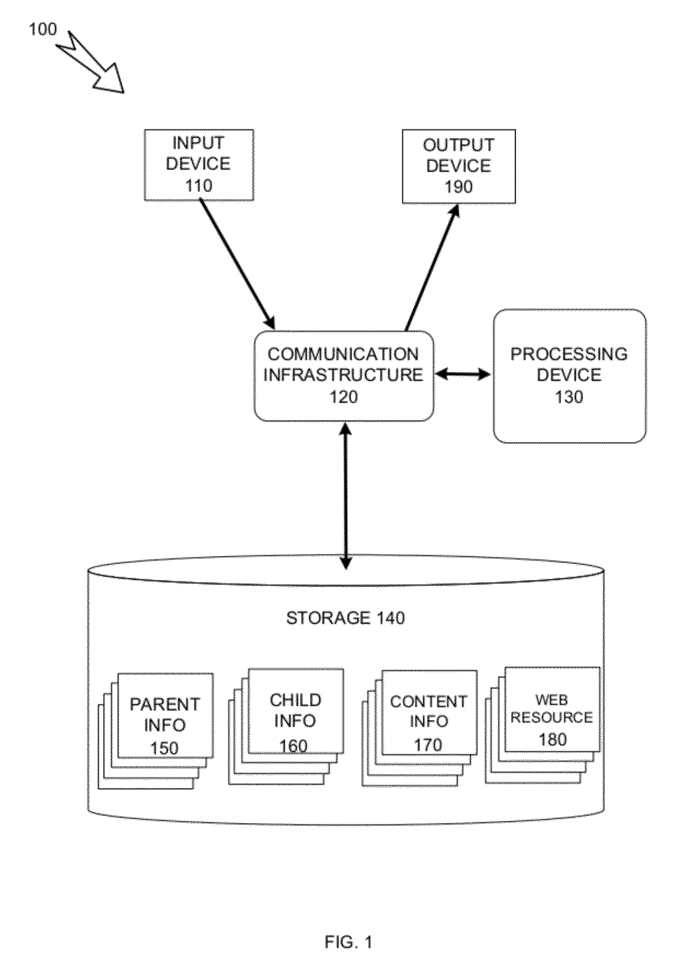

FIG. 1 depicts an illustrative high-level device processing system 100 for use with an illustrative embodiment for providing resource dissemination. System 100 may include input device 110, communication infrastructure 120, processing device 130, storage 140, parent information 150, child information 160, content information 170, web resource 180, and an output device 190.

Input device 110 may include a device for providing inputs to processing device 130 through communications infrastructure 120. For example, input device may receive input from a user or another device. Input device 110 may include, for example, a keyboard, track ball, touch sensitive display, haptic device, microphone, etc.

Communications infrastructure 120 may include a communication path designed to send and receive data. For example, communications infrastructure 120 may include a communications bus, cross-over bar, interconnect, network, etc. Communications infrastructure 120 may, for example, interface devices to computer systems (e.g., bus) or interface computer systems to each other (e.g., network).

Processing device 130 may include logic configured to execute computer-executable instructions that implement illustrative embodiments. The instructions may reside in storage 140. An example processing device that may be used includes processors available from Intel Corporation, Santa Clara, Calif. (e.g., Xeon, Pentium, etc).

Storage 140 may include a computer-readable medium that may be configured to store instructions configured to implement illustrative embodiments of the invention. Storage 140 may be a primary storage accessible to processing device 130 and may include a random-access memory (RAM) that may include RAM devices, such as, for example, hard drives, Dynamic RAM (DRAM) devices, flash memory devices, Static RAM (SRAM) devices, etc. Storage 140 may store parent information 150, child information 160, content information 170, and/or web resource 180.

Output device 190 may include a device for providing outputs from processing device 130. Output device 190 may include, for example, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), etc.

Input device 110 (e.g., keyboards, mice, trackballs, microphones, touch screens, haptic devices, etc.) may allow input of parent information 150, child information 160, content information 170, and/or web resource 180.

Parent information 150 may be inputted into the system by a parent. Parent information 150 may include parent contact information, parent business information, and parent system 100 configuration information (e.g., system 100 preferences and/or settings). Parent contact information and business information may include a business name, a postal address, an email address, a telephone number, a business logo, a uniform resource locator (URL), a Twitter account, a Linkedin account, a Facebook account, a webstore, a blog, reviews, news, social network account, social media accounts, images, comments, videos, lead generation components, etc.

Child information 160 may be inputted into the system 100 by a child. Child information 160 may include child contact information, child business information, child dissemination targets and/or child system configuration information (e.g., system 100 preferences and/or system 100 settings). Child contact information and child business information may include a business name, a postal address, an email address, a telephone number, a business logo, a uniform resource locator (URL), a Twitter account, a Linkedin account, a Facebook account, a webstore, a blog, reviews, news, social network account, social media accounts, images, comments, videos, lead generation components, etc.

Content information 170 may be inputted by either the parent, child, or a third party. Content information may contain advertising or other marketing material. Content information 170 may include hypertext markup language (HTML) formatted data, extensible hypertext markup language (XHTML) formatted data, extensible markup language (XML) formatted data, dynamic hypertext markup language (DHTML) formatted data, audio data, graphic data, video data, image data, Flash, JavaScript, portable document format (PDF) data, joint photographic experts group (JPEG) data, portable networks graphic (PNG) data, tagged image file format (TIFF) data, graphics interchange format (GIF) data, etc.

Web resource 180 may include a webpage or other resource or resources that may be suitable for the World Wide Web and may be accessed via a web browser (e.g., but not limited to, Internet Explorer, Firefox, Opera, Safari, etc.), or other web accessible application. Web resource 180 may include hypertext markup language (HTML) formatted data, extensible hypertext markup language (XHTML) formatted data, extensible markup language (XML) formatted data, dynamic hypertext markup language (DHTML) formatted data, audio data, graphic data, video data, image data, Flash, JavaScript, portable document format (PDF) data, joint photographic experts group (JPEG) data, portable networks graphic (PNG) data, tagged image file format (TIFF) data, graphics interchange format (GIF) data, cascading style sheets (CSS) formatted data, etc.

Processing device 130 may create one or more web resource 180 using parent information 150, child information 160, and/or content information 170. In one embodiment, processing device 130 may selectively replace parent information 150 (e.g., parent contact information) with child information 160 (e.g., child contact information) in web resource 180. Embodiments may be configured to automatically replace parent information 150 with child information 160 or may require child permission to complete the replacement. Indication as to whether automatic replacement occurs may be stored in system 100 configuration settings, for example.

Processing device 130 may transmit web resource 180 to output device 190 via communications infrastructure 120. Processing device 130 may disseminate web resource 180 to child contacts listed in the child information 160, parent contacts listed in the parent information 150, or a combination of parent and child contacts. Embodiments may be configured to automatically disseminate web resource 180 to child contacts or may require child permission to transmit the web resource. Indication as to whether automatic dissemination occurs may be stored in system 100 configuration settings.

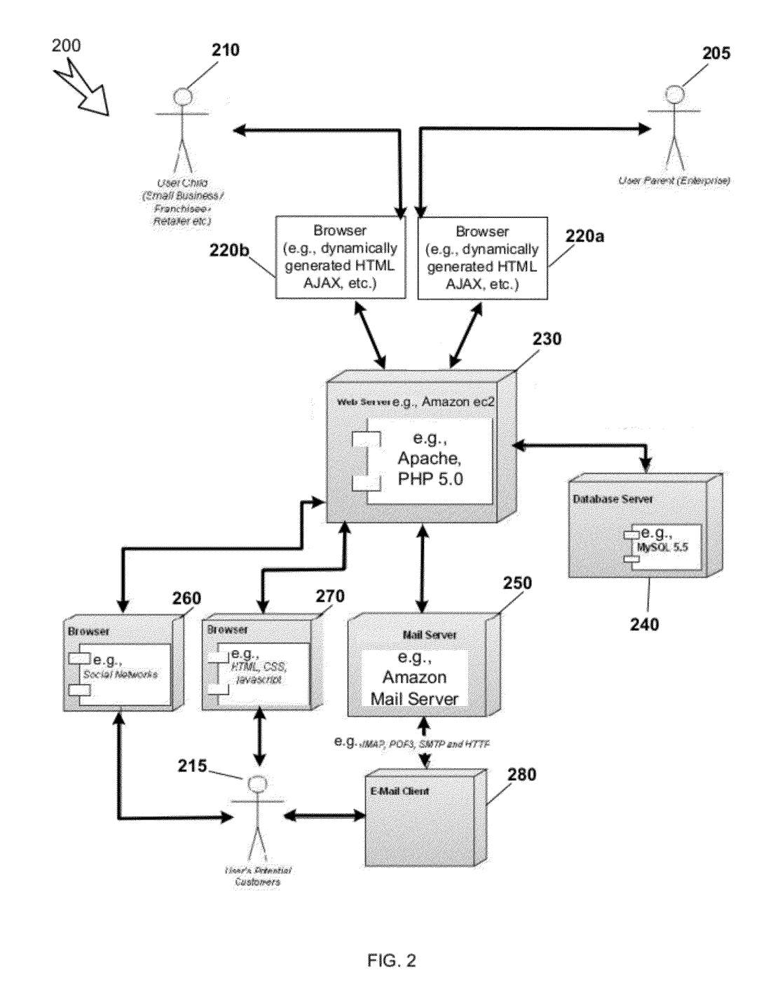

FIG. 2 depicts an illustrative distribution system 200 for use with an illustrative embodiment for providing resource dissemination. System 200 may communicate with parent 205, child 210, and dissemination targets 215. System 200 may also include parent interface 220a and child interface 220b (collectively parent and child interfaces 220) as well as dissemination target interfaces such as social network interface 260, web distribution interface 270, and/or mail user agent 280. System 200 may include a server 230, database 240, and/or mail server 250.

Parent 205 may include content creators, for example, a manufacturer, a franchisor, a distributor, a wholesaler, an enterprise, a service provider, a realtor, a plumber, an electrician, etc.

Child 210 may include content distributors, for example, a retailer, a distributor, a franchise, a customer, a service provider, a lender, a plumber, an electrician, etc. Child 210 may disseminate content created by parent 205. Child 210 may also create content (similar to parent 205) without a parent 205. In one embodiment, parent 205 may distribute created content to another parent. Also possible, child 210 may deliver content to another child.

Dissemination targets 215 may include potential customers, current customers, business associates, employees, employers, organizations, network groups, associations, partners, referrals, communities, companies etc.

Parent and child interfaces 220 may include a web browser, dedicated software application, or other interface that allows parent 205 and/or child 210 to interface with server 230. Parent and child interfaces 220 may include input device 110, output device 190, communications infrastructure 120, processing device 130, and storage 140. Using input device 110, processing device 130, and communications infrastructure 120 parent and child interfaces 220 may allow parent 205 and/or child 210 to input and upload child information 160, parent information 150, content information 170, and/or instructions to server 230. Communication between parent and child interfaces 220 and server 230 may occur using HTTP, for example, or other protocol for transferring information. Using output device 190, processing device 130, and/or communications infrastructure 120, parent and child interfaces 220 may allow parent 205 and/or child 210 to download and view child information 160 and parent information 150, content information 170, web resource 180, and/or instructions from server 230. Parent and child interfaces 220 may communicate with or be part of server 230.

Server 230 may include a web server such as an Apache server, Microsoft IIS, Amazon Elastic Compute Cloud (Amazon EC2), etc. Server 230 may include input device 110, output device 190, communications infrastructure 120, processing device 130, and storage 140. Server 230 may provide web resource 180 to dissemination targets 215. Server 230 may communicate with or be a part of database 240.

Database 240 may include a system intended to organize and store data in for example, a relational database. Database 240 may include databases such as MySQL, PostgreSQL, Microsoft Access, SQL Server, FileMaker, Oracle, Sybase, dBASE, Clipper, FoxPro, etc. Database 240 may include input device 110, output device 190, communications infrastructure 120, processing device 130, and storage 140. Database 240 may also include parent information 150, child information 160, content information 170, and/or web resource 180.

Mail server 250 may include a system intended to deliver and receive mail to and from other systems. Mail server 250 may include mail servers such as Apache James, Atmail, CommuniGate Pro, Microsoft Exchange, Sendmail, Postfix, Exim, Amazon Mail Server, etc. Mail server 250 may deliver email communications from parent 205 and/or child 210 to dissemination targets 215. Mail server 250 may transmit and receive communications from mail user agent 280 via protocols such as IMAP, POP3, SMTP, and HTTP.

Mail user agent 280 may be a system used to manage email or allow access to an email mailbox. Email may be accessible through a number of means such as via a computer or mobile phone. Mail user agent 280 may include mail tools such as Gmail, Yahoo Mail, Microsoft Outlook, Thunderbird, Apple Mail, Pegasus Mail, Hotmail, etc. Mail user agent 280 may allow dissemination targets 215 to view email from parent 205 and/or child 210.

Another method of dissemination of communications from parent 205 and/or child 210 may be through social networks via a social network interface 260. Social networks may include, Twitter, Facebook, Linkedin, etc. Social network interface 260 may include a web browser, dedicated software application, or other interface (e.g., mobile phone, tablet computer, personal digital assistant, etc.) that may allow dissemination targets 215 to interface with social networks.

Another method of dissemination of communications from parent 205 and/or child 210 may be through web distribution via web distribution interface 270. Web distribution may include newsfeeds, search engines, websites, blogs, etc. Web distribution interface 270 may include a web browser, dedicated software application, or other interface that may allow dissemination targets 215 to view web resource 180.

In another embodiment, parent 205 may create a content library containing, for example, pdf, jpeg, video, doc, html, xhtml, dhtml, image data, flash, javascript, gif, etc. The library may be made available to one or more children. Content library may be stored in, for example, database 240. Child 210 may be able to access content library by, for example, clicking through a drop-down box and populating web resource 180 with content from content library. Content in content library may be made available in both editable and non-editable forms. Once content from content library is retrieved and used for the web resource 180, child 205 may disseminate the web resource to the dissemination targets.

In another embodiment, parent 205 may distribute content through multiple children. Also, child 210 may receive content through multiple parents 205.

According to another embodiment, the distribution system 200 could be represented by any of a number of well-known network architecture designs including, but not limited to, services oriented architecture (SOA), peer-to-peer, client-server, hybrid-client (e.g., thin-client), distributed computing, cloud computing, standalone, etc. A standalone system (not shown) may exist where information may be distributed via a medium such as, e.g., a computer-readable medium, such as, e.g., but not limited to, a compact disc read only memory (CD-ROM), and/or a digital versatile disk (DVD), BLUERAY®, etc.

### Illustrative Processing

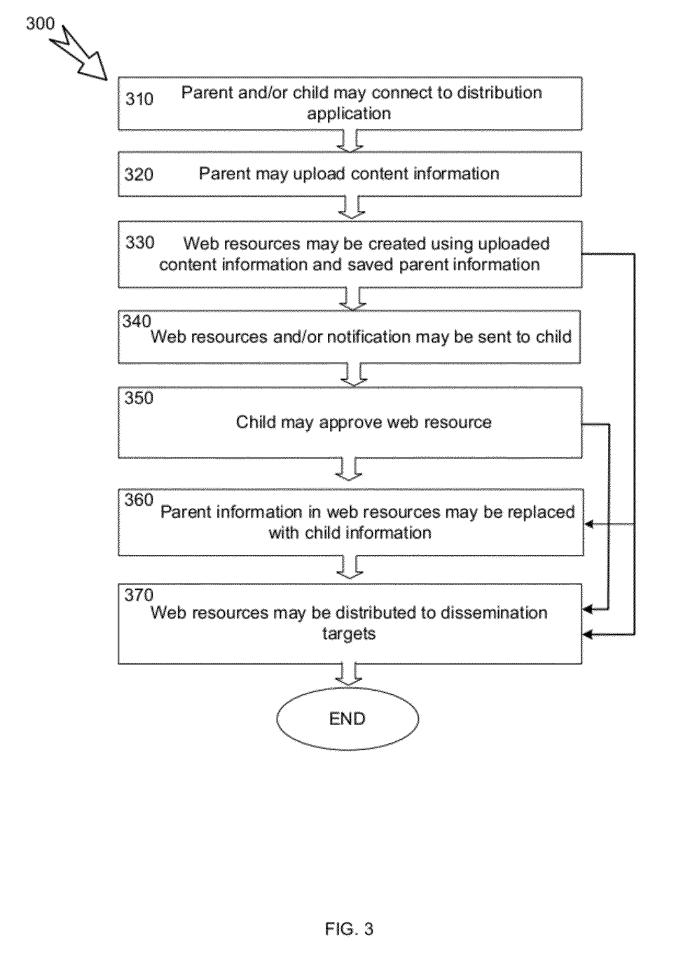

FIG. 3 illustrates example distribution flowchart 300 describing processing performed in an illustrative embodiment. Parent 205 and/or child 210 may connect to distribution application (block 310). An example distribution application interface may include parent and child interfaces 220.

Parent 205 may upload content information 170 (block 320). Content may be uploaded using parent and child interfaces 220 to server 230 and may be stored in database 240. Parent 205 and/or child 210 may also store parent information 150 and child information 160 in database 240.

Web resource 180 may be created (e.g., using processing device 130) based on the content uploaded in block 320 and saved parent information 150 (block 330). Web resource 180 may be saved in database 240. Depending on the configuration of system 100 (e.g., system 100 preferences and settings), from block 330 flow may proceed to block 340, block 360 or block 370. If, for example, the system 100 is configured to have child 210 approve web resource 180 prior to dissemination, flow may move to block 340. Alternatively, system 100 may be configured to disseminate web resource 180 without child 210 approval and flow may move to block 360 or 370. If parent information 150 is to be replaced with child information 160 without child approval, flow may move from 330 to 360. If parent information 150 remains in web resource 180, then flow may move to 370 for distribution of web resource 180 to dissemination targets 215.

Web resource 180 and/or notification may be sent to child 210 (block 340). Child 210 may receive a notification that web resource 180 is available for review.

Child 210 may approve web resource 180 (block 350). After reviewing web resource 180 child 210 may approve or reject the web resource 180. If, for example, child 210 rejects web resource 180, a notification may be sent to parent 205 for review. If, for example, child 210 accepts web resource 180, flow may move to block 360. In some embodiments, depending, for example on the system 100 settings, flow may move to 370.

Parent information 150 in web resource 180 may be replaced with child information 160 (block 360). Parent contact information, for example, may be replaced with child contact information. System 100 settings may determine which parent information 150 in web resource 180 may be replaced with corresponding child information 160. In some embodiments, depending, for example on the system 100 settings, parent information 150 in web resource 180 may not be replaced with child information 160 and flow may move to 370.

Web resource 180 may be distributed to dissemination targets 215 (block 370). Dissemination targets 215 may receive web resource, for example, via social network interface 260, web distribution interface 270, and/or mail user agent 280. In some embodiments, parent information 150 may remain in the disseminated web resource 180. In other embodiments, parent information 150 in web resource 180 may be automatically replaced by child information 160 prior to dissemination.

### Example Embodiments

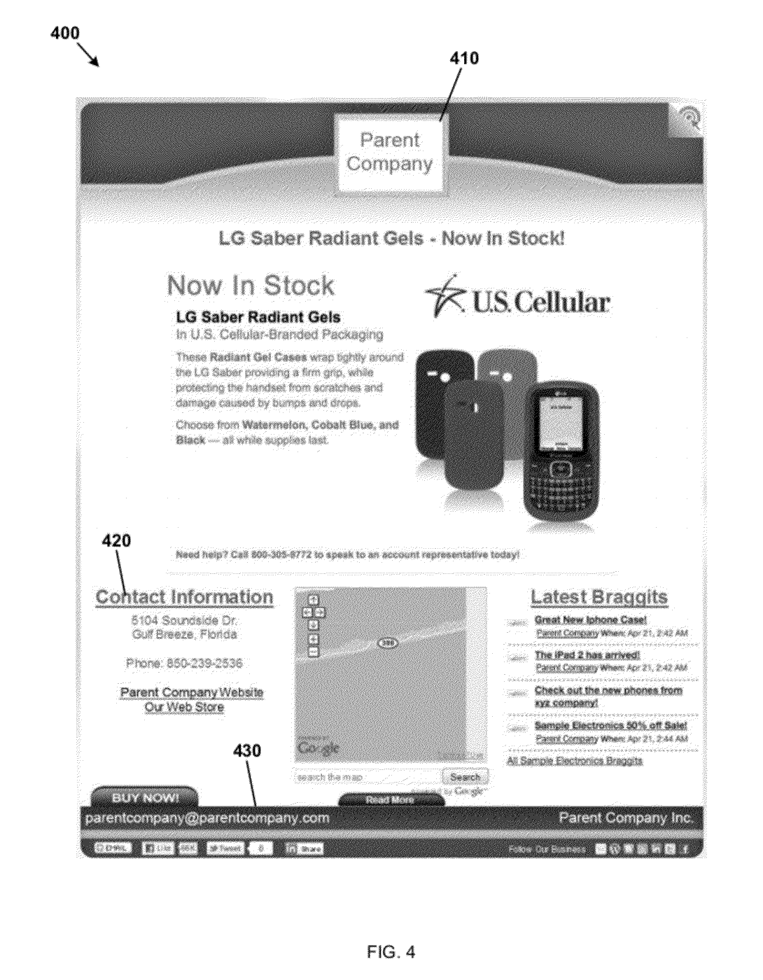

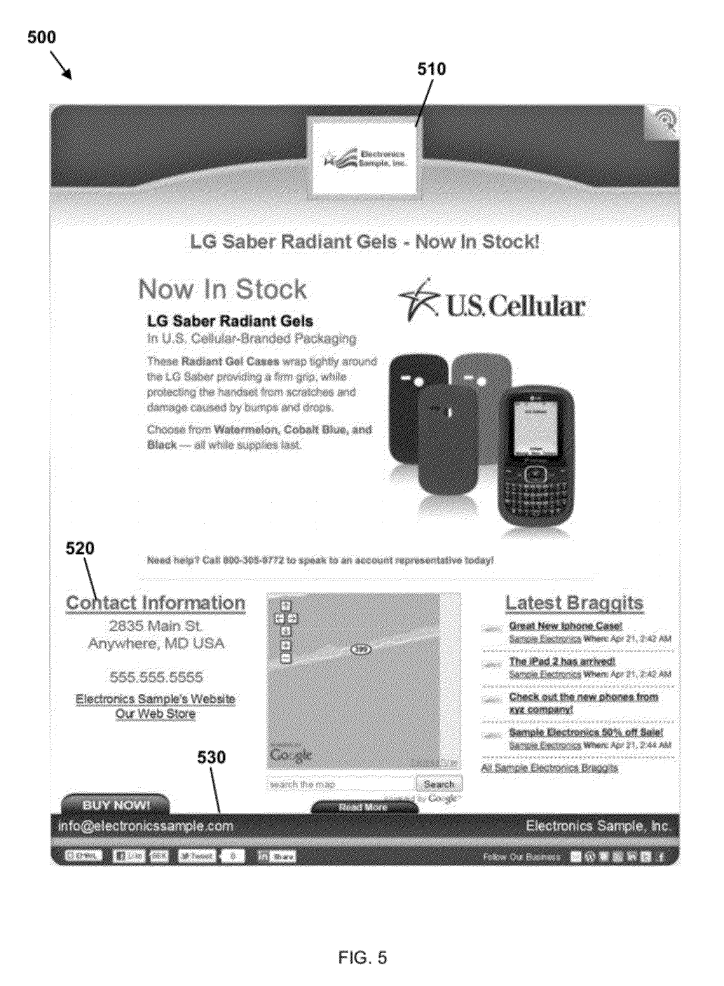

FIG. 4 illustrates an example screenshot of a webpage 400 containing parent information 150 in an illustrative embodiment of the invention. Webpage 400 may contain one or more web resources 180. Webpage 400 may have been created from parent information 150 and content information 170. Webpage 400 may contain parent logo 410, parent contact information 420, and parent information bar 430. Parent information bar 430 may contain parent company name and email address, for example. Webpage 400 may be transmitted to dissemination targets 215 or may have parent information 150 replaced with child information 160 as shown in FIG. 5. Webpage 500 may be transmitted to dissemination targets 215 with or without child 210 approval.

FIG. 5 illustrates an example screenshot of a webpage 500 containing child information 160 in an illustrative embodiment of the invention. Webpage 500 may contain one or more web resources 180. Webpage 500 may contain child logo 510, child contact information 520, and child information bar 530. Child information bar 530 may contain child company name and email. Webpage 500 may illustrate the replacement of parent information 150 with child information 160. For example, child logo 510, child contact information 520, and child information bar 530 may have replaced parent logo 410, parent contact information 420, and parent information bar 430, respectively. Webpage 500 may be transmitted to dissemination targets 215 with or without child 210 approval.

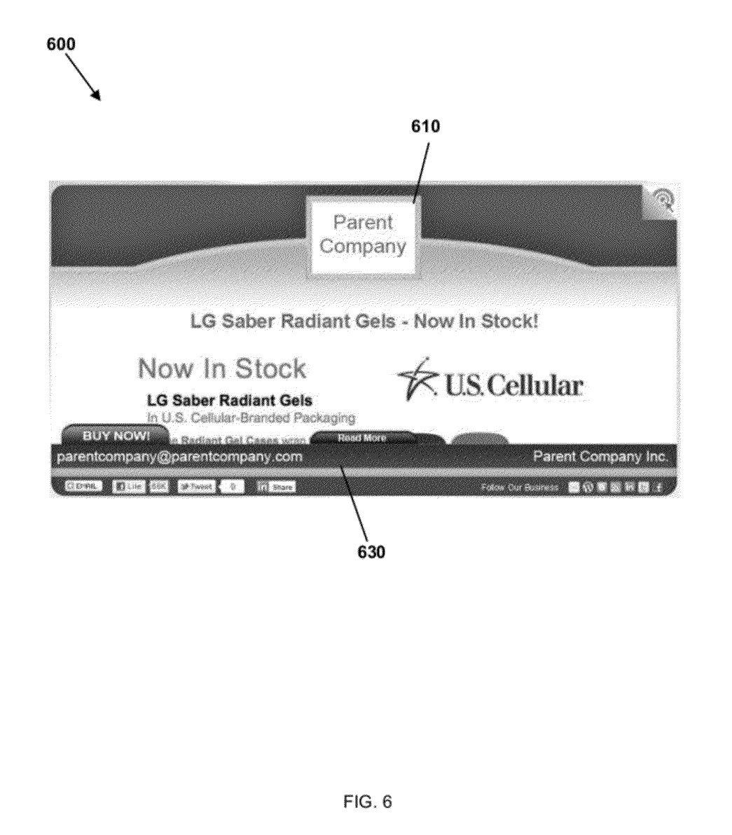

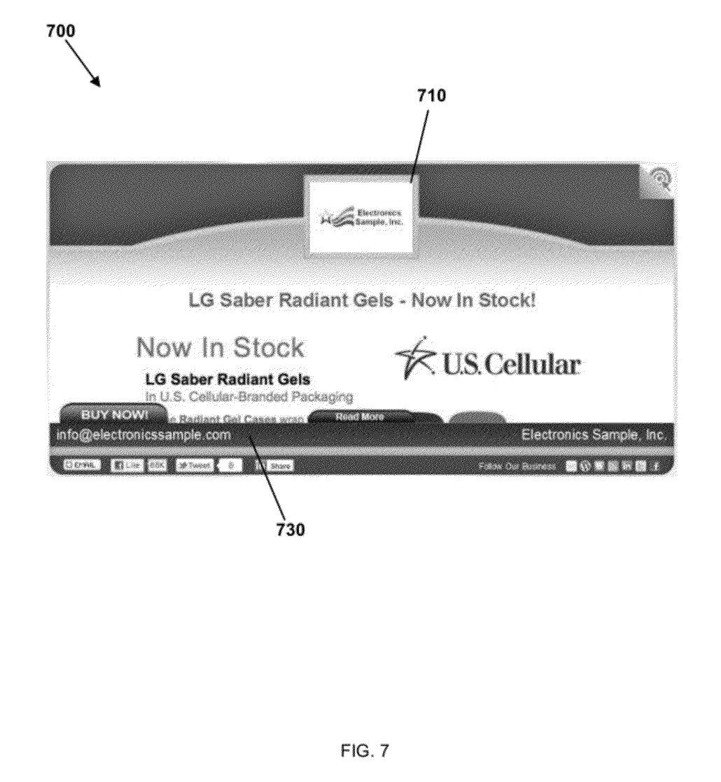

FIG. 6 illustrates an example screenshot of a reduced webpage 600 containing parent information 150 in an illustrative embodiment of the invention. Reduced webpage 600 may contain one or more web resources 180. Reduced webpage 600 may have been created from parent information 150 and content information 170. Reduced webpage 600 may contain a subset of webpage 400. Reduced webpage may contain parent logo 610 and parent information bar 630. Parent information bar 630 may contain parent company name and email address, for example. Reduced webpage 600 may be transmitted to dissemination targets 215 or may have parent information 150 replaced with child information 160 as shown in FIG. 7. Reduced webpage 600 may be transmitted to dissemination targets 215 with or without child 210 approval.

FIG. 7 illustrates an example screenshot of a reduced webpage 700 containing child information 160 in an illustrative embodiment of the invention. Reduced webpage 700 may contain one or more web resources 180. Reduced webpage 700 may contain child logo 710 and child information bar 730. Child information bar 730 may contain child company name and email. Reduced webpage 700 may illustrate the replacement of parent information 150 with child information 160. For example, child logo 710 and child information bar 730 may have replaced parent logo 610 and parent information bar 630, respectively. Reduced webpage 700 may be transmitted to dissemination targets 215 with or without child 210 approval.

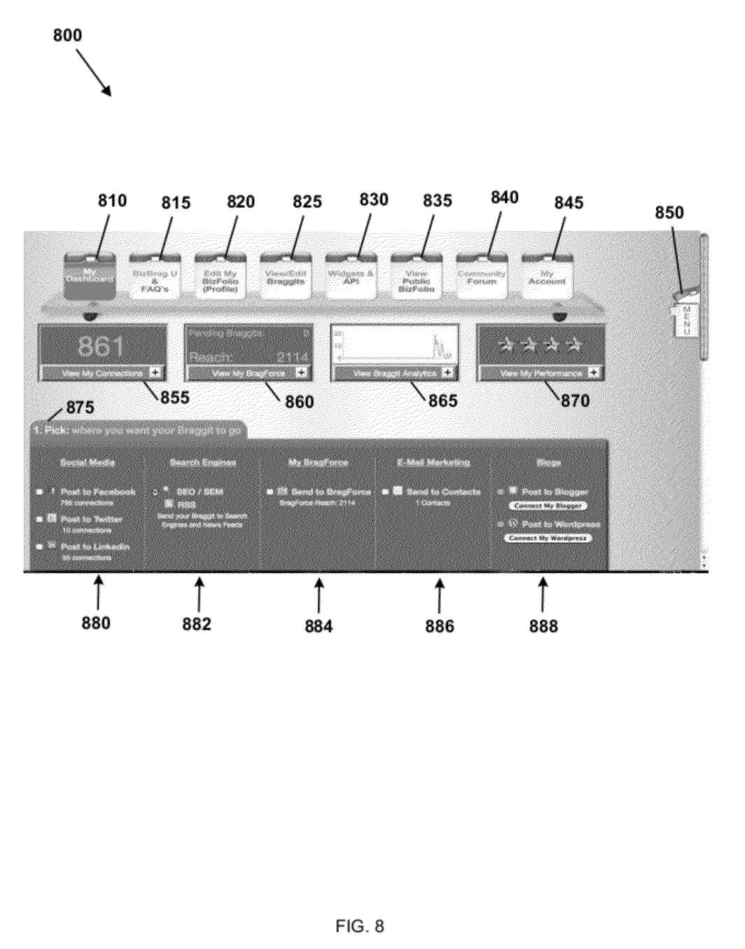

FIG. 8 illustrates an example screenshot of parent dashboard 800 in an illustrative embodiment of the invention. Dashboard 800 may contain navigation buttons such as My Dashboard button 810, BizBrag U & FAQ's button 815, Edit my Bizfolio (profile) button 820, view/edit Braggits button 825, Widgets & API button 830, View Public BizFolio button 835, Community Forum button 840 and My Account button 845.

A Braggit may be an article, announcement, video, brochure, sales sheet, etc., that may become a web resource 180 (e.g., webpage 400) once created. The Braggit may be populated with parent information 170. For example, the parent information 170 may be extracted from the parent's BizFolio (e.g., the business profile page on BizBrag.com). Parent's contact information may include a website or website address, a postal address, a telephone number, a map location, social media connections, social network connections, email capture components, logo, past Braggits, reviews, etc. For example. once the Braggit has been created, the parent 205 may send the Braggit to the child 210 via the BragForce, from the parent dashboard 800 on BizBrag.com.

The BizFolio may be, for example, the BizBrag members' (e.g., parent 205 and/or child 210) business profile page. The member may enter information about their business and this information may be stored on database 240. Once the data is stored, the BizFolio information may be programmatically inserted into each Braggit, for example, that a member creates. For example, the BizFolio information may be used to programmatically populate and display the contact information on each Braggit that a member creates. So, for example, the business profile/contact information that may be on each Braggit, may be programmatically retrieved from the BizFolio information to customize each Braggit for the purposes of, for example, lead generation and general business information dissemination.

The BragForce may be, for example, BizBrag's social online marketing network. The BragForce may encompass connections of members between each other. One way in which members may connect may be by logging in to BizBrag, finding a member's Braggit or BizFolio through a search and clicking on the ‘Join Our BragForce’ tab, for example. Other ways in which a member may join another member's BragForce is by finding their BizBrag or BizFolio on the web and clicking on the ‘Join Our BragForce’ tab. Yet another way in which a BizBrag community member may join another BizBrag community member's BragForce may be by clicking on the ‘Join Our BragForce’ tab in an email that may be delivered via a Braggit, for example. Another scenario in which a member joins another member's BragForce may be specific to the Parent-Child relationship. Parent 205 may have a dedicated sign-up URL for the child 210 to visit for signing up to BizBrag and becoming a BizBrag community member, for example. When child 210 signs up to BizBrag via the custom URL dedicated to parent 205, child 210 may be programmatically (e.g., automatically) joined to the parent's 205 BragForce. Parent's 205 custom URL may be obtained by, for example, parent 205 visiting BizBrag's registration page and registering for the custom URL for signing up one or more children to BizBrag services through that URL and creating, for example, an automatic connection. Each member may create their own BragForce, which may be made up of connections to other BragForce members. The BragForce may assist in dissemination of Braggits by sending each BragForce connection a Braggit and having each BragForce connection pass those Braggits along to their own social network and email connections (along with creating as a blog post, for example).

The parent/child connection may mean that both the parent 205 and child 210 are in each other's BragForce and parent 205 may be the entity that, for example, creates the content. For example, member B joins members A's BragForce. Member A sends member B a Braggit with member A's content and contact information. Member B then forwards this Braggit onto to member B's network connections (social), email contacts, blogs, search engines, etc. Member B's contact information and/or content may replace or augment member A's contact information and/or content. Alternatively, member A's original content and contact information may stay intact. An inverse relationship may occur, where member B may send a Braggit to member A and the same process takes place. Some organizations may have a sales force to sell products, BizBrag may give every community member the opportunity to build their ‘BragForce’ in order to help each other brag about their businesses.

Clicking on My Dashboard button 810 may display dashboard 800. Dashboard 800 may display a connections screen 855, BragForce screen 860, Braggit Analytics screen 865, and a Performance screen 870.

Connections screen 855 may depict the number of current connections and may allow a user to view all their connections.

Connections screen 855 may allow a member to manage connections. Managing connections may include, for example, making or disconnecting connections, adding or removing contacts, visiting member's account that applies to those connections (e.g., a one-click hyperlink that re-directs the member directly to the member's Facebook, LinkedIn, Twitter accounts, etc.), searching for new connections, providing information on how to make connections, and/or connecting multiple connections within one connection location (e.g., more than two Facebook accounts).

BragForce screen 860 may depict the current number of pending Braggits and the reach and may allow the user to retrieve additional information on the BragForce.

BragForce screen 860 may allow a member to take an action regarding pending Braggits. Actions may include, for example, forwarding a Braggit to specific locations one-by-one, forwarding a Braggit to a specific location at the same time, rejecting a pending Braggit, viewing connections from the sender of a pending Braggit, viewing the BizFolio (e.g., business profile) of the sender of a pending Braggit, viewing BragForce invites, managing BragForce invites, viewing BragForce messages, managing BragForce messages, searching for additional BragForce members, viewing current BragForce members and/or managing current BragForce members.

Braggit Analytics screen 865 may depict the current status of the user's Braggits and may allow the user to retrieve additional information on the user's Braggits.

Performance screen 870 may depict the user's current performance and may allow the user to retrieve additional information on the user's performance.

From dashboard 800 a user (e.g., parent 205) may create a Braggit. The user may choose how the Braggit should be disseminated by using for example, the pick section 875 of Dashboard 800. Pick section 875 may include social media selection 880, search engine selection 882, BragForce selection 884, email marketing 886, and/or blogs 888, for example.

In an illustrative embodiment, a user may create a Braggit, for example, by typing or uploading content into the appropriate web enabled form.

Braggits may be programmatically populated using, for example, information from the BizFolio. The BizFolio may be a BizBrag members' business profile page. When a prospective member (e.g., parent 205 and/or child 210) joins BizBrag, for example, they may fill in a sign up form. This form may request the following: email address, password, contact name and/or business name, for example. Once a prospective member has completed the sign up form, the email address, contact name and business name may be used to programmatically create a personalized BizFolio (e.g., a business profile page for that member). Each BizFolio (profile page) may receive a unique URL. By having a unique URL search engines may be able to discover and link to the URL. Additionally, the URL makes the BizFolio shareable and accessible across the web.

A member may edit the personalized BizFolio (profile) page and add additional information, including, but not limited to: logo, slogan, key people, webstore URL, blog URL, key words, business color scheme, business information, contact information, products, services offered, etc. The contents of the BizFolio may be available on the server to allow BizBrag's technology to programmatically retrieve contact information from the BizFolio and place the information into a created Braggit. This ‘on demand’ supply of contact information may free the member from having to supply/type in the contact information into each Braggit that he/she creates. The BizBrag technology may programmatically retrieve the contact information from the server where the contact information is stored. The information in the BizFolio may be updated at anytime and may change in real-time so that each Braggit may always retrieve the latest contact information.

Child 210 contact information may be programmatically retrieved from the child's BizFolio information stored on the servers. Child 210 contact information may replace parent 205 contact information. Parent 205 contact information may have originally been placed in the Braggit via parent 205 BizFolio which may have been also stored on the servers programmatically. No user interface may be needed to ‘switch’ the child/parent contact information retrieved from the servers which may have been originally keyed in and stored in the BizFolio.

A member may enter information about their business into the given fields and this information may be stored on the servers so that the information may be programmatically inserted into each Braggit that member creates. This BizFolio information may be used to populate and display contact information on each Braggit, programatically, that a member creates. The business profile/contact information that is on each Braggit, may be programmatically retrieved from the BizFolio information. Braggits may be customized for the purposes of lead generation and general business information dissemination.

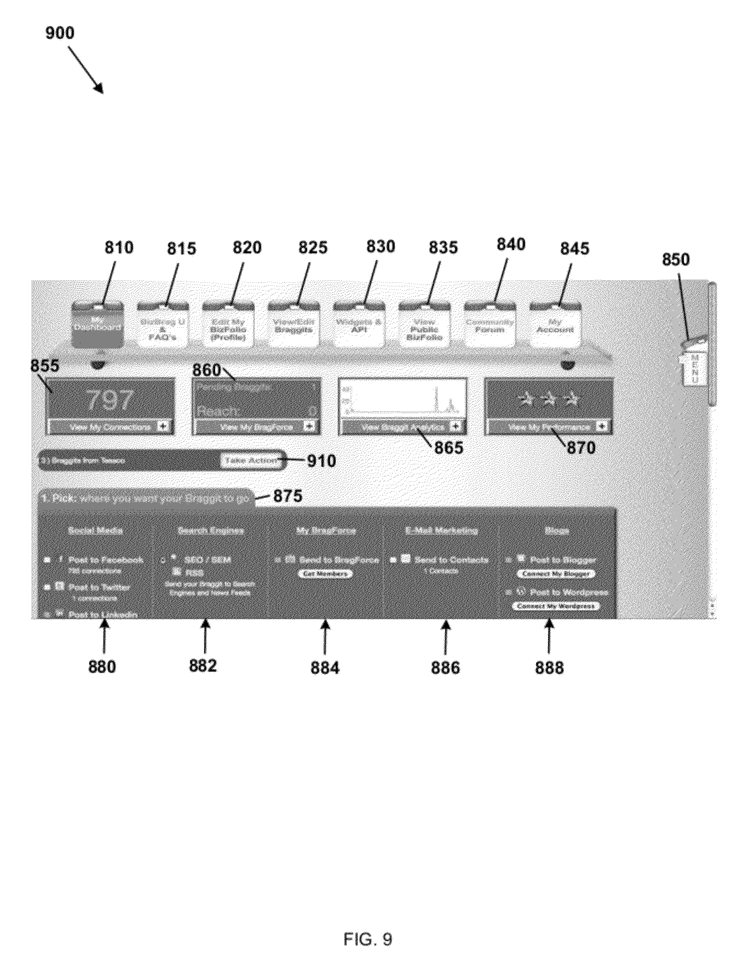

FIG. 9 illustrates an example screenshot of child dashboard 900 in an illustrative embodiment of the invention. When a Braggit is received by child 210, child dashboard 900, in addition to similar buttons as parent dashboard 800, may also contain a take action button 910 for the received Braggit. The child 210 may also receive a notification (e.g., via email, text message, page, etc.) that there is a Braggit from the parent 205 waiting for their attention in their BizBrag dashboard/account.

From child dashboard 900, a child 210 may be able to access a content library previously created by parent 205.

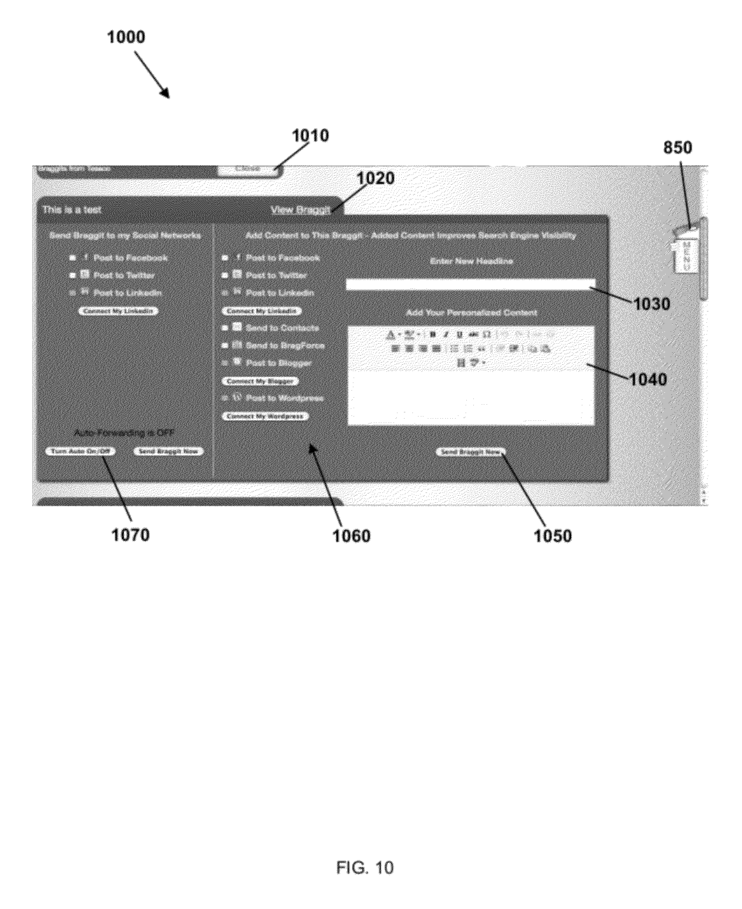

Take action button 910 may allow child 210 to view, edit, and transmit the Braggit. When take action button 910 is selected, a screen such as FIG. 10 may be displayed.

FIG. 10 illustrates an example take action screenshot 1000 in an illustrative embodiment of the invention. Take action screenshot 1000 may have close button 1010, view Braggit link 1020, new headline field 1030, personalized content field 1040, distribution information 1060, send Braggit now button 1050, and/or an auto-forwarding button 1070.

Close button 1010 may close the editing of the current Braggit and bring the user back to dashboard 800, for example.

New headline field 1030 may allow the child 210 to insert a new headline into the Braggit.

Personalized content field 1040 may allow the child to insert new content into the Braggit.

View Braggit link 1020 may allow the child 210 to view the Braggit with any changes made using new headline field 1030 or personalized content field 1040.

Distribution information 1060 may allow the child 210 to select the various methods to transmit the Braggit to dissemination targets 215.

Auto-forwarding button 1070 may cause the Braggit and/or future Braggits to be transmitted to dissemination targets 215 without child 210 interaction.

Once child 210 takes action with parent's Braggit (e.g., automatically or manually) and sends web resource 180 to child 210 social connections, contacts and search engines from dashboard 900, all of the auto-populated information on the Braggit from the parent's BizFolio may be “switched” and auto-populated with the child's information from their own BizFolio. The content may remain the same or be altered by the child. The second scenario is that the “switch” of contact information may not occur and the parent contact information is sent to the child's network connections (e.g., dissemination targets 215).

The Braggit may then be distributed and viewed across the web (e.g., social media, social networks, email contacts, search engines, etc.) containing child information 160 or the parent information 150.

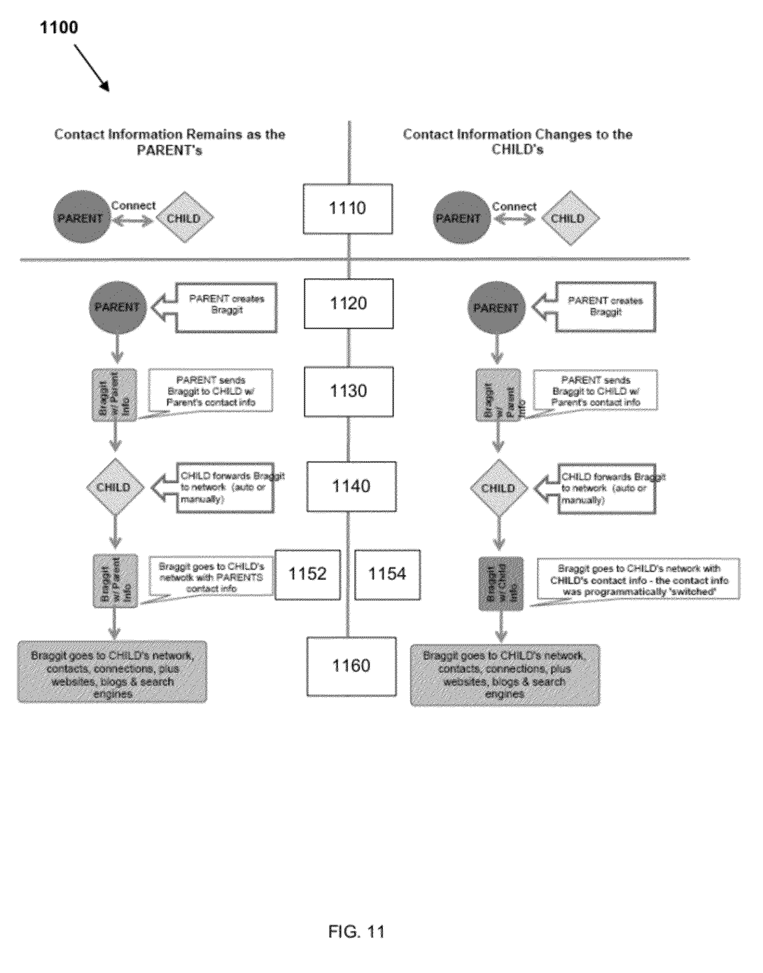

FIG. 11 depicts example flowcharts 1100 describing Braggit processing performed in an illustrative embodiment. Parent 205 and/or child 210 may connect to parent dashboard 800 and/or child dashboard 900, respectively (block 1110). Both parent information 150 and child information 160 may be created and stored in their respective BizBrag.com business profile (e.g., BizFolio). When creating a Braggit, both parent information 150 and child information 160 may be automatically pulled from the profiles to populate the Braggit. On Braggit creation, the parent 205 may determine whether a switch should occur where child information 160 replaces parent information 150 in the Braggit or whether the parent information 150 remains in the Braggit.

Parent 205 may create a Braggit (block 1120).

Parent 205 may send Braggit containing parent 205 information to child 210 (block 1130).

Child 210 may forward the Braggit to dissemination targets 215 (block 1140). Flow may proceed to 1152 when parent information 150 remains with the Braggit. Alternatively, flow may proceed to 1154 when child information 160 replaces parent information 150 in Braggit.

Braggit may go to child 210 contacts with parent information 150 (block 1152).

Braggit may go to child 210 contacts with child information 160 (block 1152). Parent information 150 may be replaced with child information 160.

Braggit may be sent to dissemination targets 215 (block 1160).

### Example Software Implementation

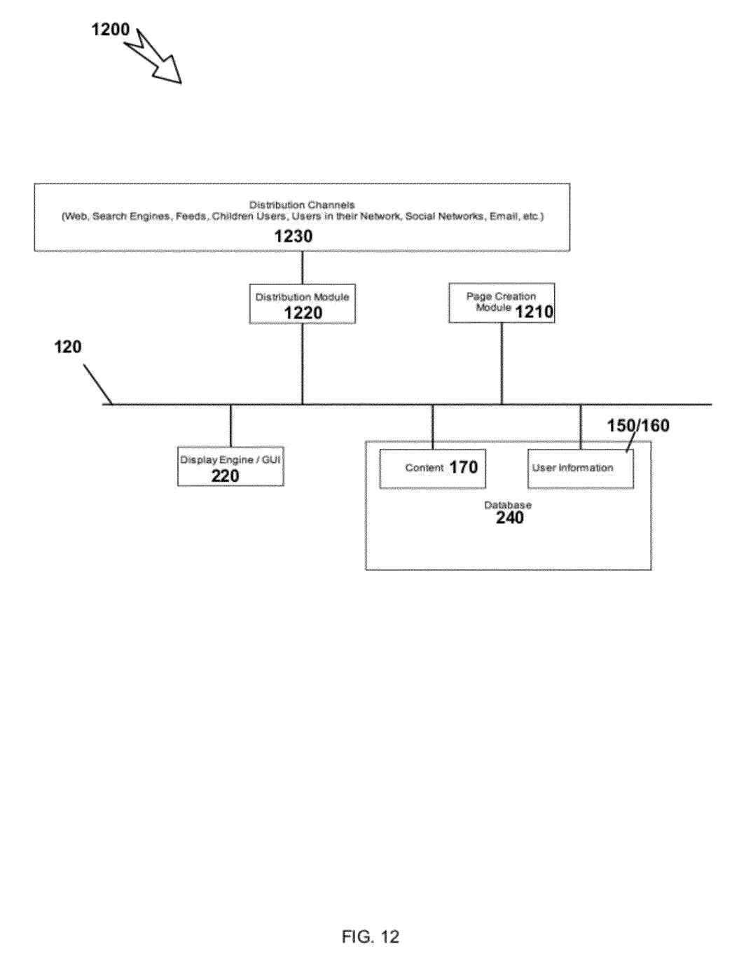

FIG. 12 depicts example high-level software modules for use with an illustrative embodiment for providing resource dissemination.

A parent 205 or child 210 may enter user information (e.g., parent information 150 and child information 160) using a graphical user interface supplied by parent and child interfaces 220. User information may be stored in database 240.

Parent 205 may submit additional information by filling out a form that may be submitted to page creation module 1210. Page creation module 1210 may combine content information 170, which may have been submitted by parent 205, with parent information 150 to create a web resource 180 such as a webpage. Web resource 180 may be sent to all of parent's children via the distribution module 1220. Children who received the web resource 180 may then add content or choose to leave the web resource as is. Once child 210 makes a decision a new web resource 180 may be created using content information 170, child information 160, parent information 150, and/or any new content child 210 may have provided.

Web resource 180 may be distributed through various distribution channels 1230 including members of parent 205 and child 210 network, children users, email, social networks, search engines, feeds, etc.

### Illustrative Computer System

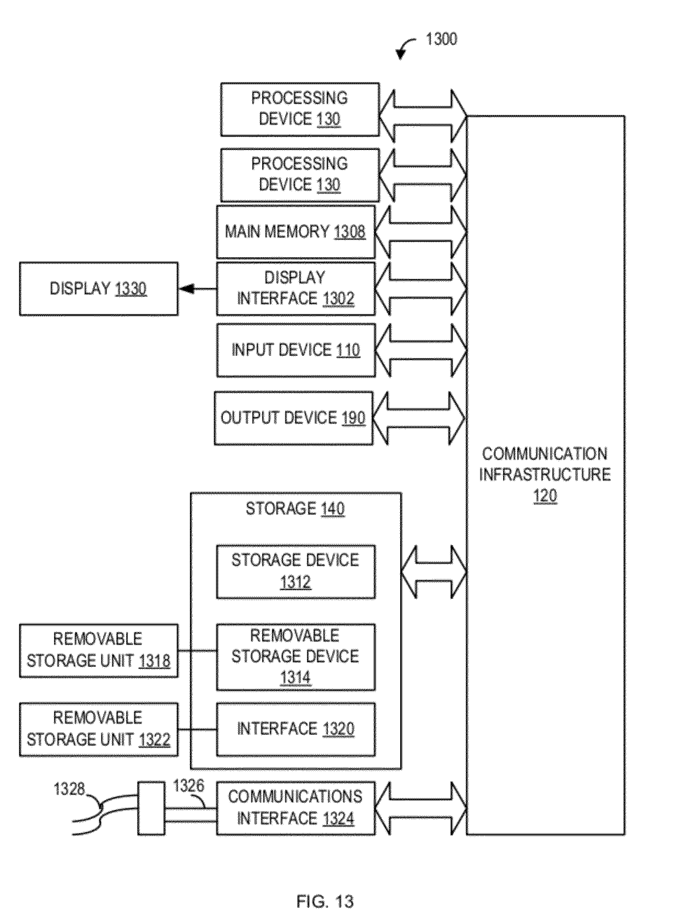

FIG. 13 depicts an illustrative computer system that may be used in implementing an illustrative embodiment of the present invention. Specifically, FIG. 13 depicts an illustrative embodiment of a computer system 1300 that may be used in computing devices such as, e.g., but not limited to, standalone or client or server devices. FIG. 13 depicts an illustrative embodiment of a computer system that may be used as client device, or a server device, etc. The present invention (or any part(s) or function(s) thereof) may be implemented using hardware, software, firmware, or a combination thereof and may be implemented in one or more computer systems or other processing systems. In fact, in one illustrative embodiment, the invention may be directed toward one or more computer systems capable of carrying out the functionality described herein. An example of computer system 1300 is shown in FIG. 13, depicting an illustrative embodiment of a block diagram of an illustrative computer system useful for implementing the present invention. Specifically, FIG. 13 illustrates an example computer 1300, which in an illustrative embodiment may be, e.g., (but not limited to) a personal computer (PC) system running an operating system such as, e.g., (but not limited to) MICROSOFT® WINDOWS® NT/98/2000/XP/Vista/Windows 7/etc. available from MICROSOFT® Corporation of Redmond, Wash., U.S.A. or an Apple computer executing MAC® OS from Apple® of Cupertine, Calif., U.S.A. However, the invention is not limited to these platforms. Instead, the invention may be implemented on any appropriate computer system running any appropriate operating system. In one illustrative embodiment, the present invention may be implemented on a computer system operating as discussed herein. An illustrative computer system, computer 1300 is shown in FIG. 13. Other components of the invention, such as, e.g., (but not limited to) a computing device, a communications device, a telephone, a personal digital assistant (PDA), an iPhone, a 3G wireless device, a wireless device, a personal computer (PC), a handheld PC, a laptop computer, a smart phone, a mobile device, a netbook, a handheld device, a portable device, an interactive television device (iTV), a digital video recorder (DVR), client workstations, thin clients, thick clients, fat clients, proxy servers, network communication servers, remote access devices, client computers, server computers, peer-to-peer devices, routers, web servers, data, media, audio, video, telephony or streaming technology servers, etc., may also be implemented using a computer such as that shown in FIG. 13. In an illustrative embodiment, services may be provided on demand using, e.g., an interactive television device (iTV), a video on demand system (VOD), via a digital video recorder (DVR), and/or other on demand viewing system.

Computer system 1300 may include one or more processors, such as, e.g., but not limited to, processing device 130. Processing device 130 may be connected to communication infrastructure 120 (e.g., but not limited to, a communications bus, cross-over bar, interconnect, or network, etc.). Processing device 130 may include any type of processor, microprocessor, or processing logic that may interpret and execute instructions (e.g., for example, a field programmable gate array (FPGA)). Processing device 130 may comprise a single device (e.g., for example, a single core) and/or a group of devices (e.g., multi-core). Processing device 130 may include logic configured to execute computer-executable instructions configured to implement one or more embodiments. The instructions may reside in main memory 1308 or storage 140. Processing device 130 may also include multiple independent cores, such as a dual-core processor or a multi-core processor. Processing device 130 may also include one or more graphics processing units (GPU) which may be in the form of a dedicated graphics card, an integrated graphics solution, and/or a hybrid graphics solution. Various illustrative software embodiments may be described in terms of this illustrative computer system. After reading this description, it will become apparent to a person skilled in the relevant art(s) how to implement the invention using other computer systems and/or architectures.

Computer system 1300 may include display interface 1302 that may forward, e.g., but not limited to, graphics, text, and other data, etc., from the communication infrastructure 120 (or from a frame buffer, etc., not shown) for display on the display unit 1330. The display unit 1330 may be, for example, a television, a computer monitor, or a mobile phone screen. The output may also be provided as sound through a speaker.

The computer system 1300 may also include, e.g., but is not limited to, main memory 1308, random access memory (RAM), and storage 140, etc. Main memory 1308, random access memory (RAM), and storage 140, etc., may be a computer-readable medium that may be configured to store instructions configured to implement one or more embodiments and may comprise a random-access memory (RAM) that may include RAM devices, such as Dynamic RAM (DRAM) devices, flash memory devices, Static RAM (SRAM) devices, etc.

Storage 140 may include, for example, (but is not limited to) hard disk drive 1312 and/or removable storage drive 1314, representing a floppy diskette drive, a magnetic tape drive, an optical disk drive, a compact disk drive CD-ROM, flash memory, etc. Removable storage drive 1314 may, e.g., but is not limited to, read from and/or write to a removable storage unit 1318 in a well known manner. Removable storage unit 1318, also called a program storage device or a computer program product, may represent, e.g., but is not limited to, a floppy disk, magnetic tape, optical disk, compact disk, etc. which may be read from and written to removable storage drive 1314. As will be appreciated, the removable storage unit 1318 may include a computer usable storage medium having stored therein computer software and/or data.

In alternative illustrative embodiments, storage 140 may include other similar devices for allowing computer programs or other instructions to be loaded into computer system 1300. Such devices may include, for example, removable storage unit 1322 and interface 1320. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM)) and associated socket, and other removable storage units 1322 and interfaces 1320, which may allow software and data to be transferred from removable storage unit 1322 to computer system 1300.

Computer 1300 may also include input device 110. Input device 110 may include any mechanism or combination of mechanisms that may permit information to be input into computer system 1300 from, e.g., a user. Input device 110 may include logic configured to receive information for computer system 1300 from, e.g. a user. Examples of input device 110 may include, e.g., but not limited to, a mouse, pen-based pointing device, or other pointing device such as a digitizer, a touch sensitive display device, and/or a keyboard, other data entry device, a biometric input device, a video source, an audio source, a microphone, a web cam, a video camera, and/or other camera (none of which are labeled).

Computer 1300 may also include output device 190 which may include any mechanism or combination of mechanisms that may output information from computer system 1300. Output device 190 may include logic configured to output information from computer system 1300. Embodiments of output device 190 may include, e.g., but not limited to, display 1330, and display interface 1302, including displays, printers, speakers, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), etc. Computer 1300 may include input/output (I/O) devices such as, e.g., (but not limited to) communications interface 1324, cable 1328 and communications path 1326, etc. These devices may include, e.g., but are not limited to, a network interface card, and/or modems.

Communications interface 1324 may allow software and data to be transferred between computer system 1300 and external devices.

In this document, the terms “computer program medium” and “computer readable medium” may be used to generally refer to media such as, e.g., but not limited to, removable storage drive 1314, a hard disk installed in hard disk drive 1312, flash memories, removable discs, non-removable discs, etc. In addition, it should be noted that various electromagnetic radiation, such as wireless communication, electrical communication carried over an electrically conductive wire (e.g., but not limited to twisted pair, CATS, etc.) or an optical medium (e.g., but not limited to, optical fiber) and the like may be encoded to carry computer-executable instructions and/or computer data that may perform embodiments of the invention on e.g., a communication network. These computer program products may provide software to computer system 1300. It should be noted that a computer-readable medium that comprises computer-executable instructions for execution in a processor may be configured to store various embodiments of the present invention.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic.

Further, repeated use of the phrase “in one embodiment,” or “in an illustrative embodiment,” do not necessarily refer to the same embodiment, although they may.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments may be embodied in many different ways as a software component. For example, it may be a stand-alone software package, or it may be a software package incorporated as a “tool” in a larger software product, such as, for example, a scientific modeling product. It may be downloadable from a network, for example, a website, as a stand-alone product or as an add-in package for installation in an existing software application. It may also be available as a client-server software application, or as a web-enabled software application. It may also be part of a healthcare provider's system (e.g., a hospital, doctor's office, etc.).

Embodiments of the present invention may include apparatuses for performing the operations herein. An apparatus may be specially constructed for the desired purposes, or it may comprise a general purpose device selectively activated or reconfigured by a program stored in the device.

Embodiments may be embodied in many different ways as a software component. For example, it may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, or as a web-enabled software application.

While various embodiments of the present invention have been described above, it should be understood that they have been presented by way of example only, and not limitation. Thus, the breadth and scope of the present invention should not be limited by any of the above-described illustrative embodiments, but should instead be defined only in accordance with the following claims and their equivalents.

What is claimed is:

1. A computer-implemented method for disseminating information, the method comprising:
receiving parent data by a first computer system from a parent computer system;
receiving child data by the first computer system from a child computer system, wherein the child data contains child contact information and child distribution information;
receiving content data by the first computer system from a parent computer system;
creating, by the first computer system, a web resource using content data;
inserting, by the first computer system, child contact information into the web resource; and
transmitting, by the first computer system, the web resource to one or more online social networking websites based on the child distribution information.

2. The method of claim 1, wherein online social networking websites comprise at least one of:
a Twitter account, a Linkedin account, or a Facebook account.

3. The method of claim 1, wherein the parent data contains parent contact information and inserting child contact information into the web resource further comprises replacing parent contact information with child contact information.

4. The method of claim 1, further comprising:
receiving a response from the child, wherein the response indicates an approval of transmitting the web resource to the one or more online social networking websites.

5. The method of claim 1, further comprising:
receiving a selection indicating no child approval is needed to transmit the web resource to the one or more online social networking websites.

6. The method of claim 3, further comprising:
transmitting the web resource to a child; and
receiving a response from the child, wherein the response indicates an approval of replacing parent contact information with child contact information in the web resource.

7. The method of claim 3, wherein the parent contact information comprises at least one of:
a business name, a postal address, an email address, a telephone number, a business logo, a uniform resource locator (URL), a Twitter account, a Linkedin account, a newsfeed, or a Facebook account.

8. The method of claim 1, wherein the child contact information comprises at least one of:
a business name, a postal address, an email address, a telephone number, a business logo, a uniform resource locator (URL), a Twitter account, a Linkedin account, a newsfeed, or a Facebook account.

9. The method of claim 1, wherein the child distribution information comprises at least one of:
an email address, a social network account, a Twitter account, a Facebook account, a Linkedin account, a newsfeed, a search engine, a website, or a blog.

10. The method of claim 1, wherein the child data is received from one of:
a retailer, a distributor, a franchise, a customer, a different service provider, a lender, or a subgroup.

11. The method of claim 1, wherein the parent data is received from one of:
a manufacturer, a franchisor, a distributor, a wholesaler, an enterprise, a service provider, or a realtor.

12. The method of claim 1, wherein the content data comprises at least one of:
hypertext markup language (HTML) formatted data, extensible hypertext markup language (XHTML) formatted data, extensible markup language (XML) formatted data, dynamic hypertext markup language (DHTML) formatted data, audio data, graphic data, video data, image data, Flash, JavaScript, portable document format (PDF) data, joint photographic experts group (JPEG) data, portable networks graphic (PNG) data, tagged image file format (TIFF) data, cascading style sheets (CSS) formatted data, or graphics interchange format (GIF) data.

13. The method of claim 1, wherein the web resource comprises at least one of:
a webpage, an information resource, hypertext markup language (HTML) formatted data, extensible hypertext markup language (XHTML) formatted data, extensible markup language (XML) formatted data, dynamic hypertext markup language (DHTML) formatted data, audio data, graphic data, video data, image data, Flash, JavaScript, portable document format (PDF) data, joint photographic experts group (JPEG) data, portable networks graphic (PNG) data, tagged image file format (TIFF) data, cascading style sheets (CSS) formatted data, or graphics interchange format (GIF) data.

14. A computer-implemented method for disseminating information, the method comprising:
accessing previously stored parent business data by a computer system;
accessing previously stored content data by the computer system;
creating a web resource by the computer system, wherein the web resource is based on content data and parent business data;
receiving, by the computer system, dissemination approval;
accessing previously stored child business data by the computer system;
replacing, by the computer system, parent business data with child business data in the web resource;
accessing previously stored dissemination targets by the computer system, wherein the dissemination targets were received from a plurality of children; and
transmitting, by the computer system, the web resource to one or more dissemination targets.

15. The method of claim 14, further comprising:
receiving a response from the child, wherein the response indicates an approval of transmitting the web resource to the one or more dissemination targets.

16. The method of claim 14, further comprising:
receiving a selection, wherein the selection indicates child approval is not required to transmit the web resource to the one or more dissemination targets.

17. The method of claim 14, wherein the computer system comprises storage for content data, parent business data, and child business data.

18. The method of claim 14, wherein the child business data comprises at least one of:
a business name, a postal address, an email address, a telephone number, a business logo, a uniform resource locator (URL), a Twitter account, a Linkedin account, a Facebook account, a webstore, a blog, reviews, news, social network account, social media accounts, images, comments, videos, or lead generation components.

19. The method of claim 14, further comprising:
receiving child content data; and
inserting child content data into the web resource prior to transmitting the web resource.

20. The method of claim 14, wherein the parent business data comprises at least one of:
a business name, a postal address, an email address, a telephone number, a business logo, a uniform resource locator (URL), a Twitter account, a Linkedin account, a Facebook account, a webstore, a blog, reviews, news, social network account, social media accounts, images, comments, videos, or lead generation components.

21. The method of claim 14, wherein dissemination targets comprise at least one of:
an email address, a social network account, a Twitter account, a Facebook account, a Linkedin account, a newsfeed, a search engine, a website, or a blog.

22. The method of claim 14, wherein the plurality of children comprise at least one of:
a retailer, a distributor, a franchise, a customer, a service provider, a lender, or a subgroup.

23. The method of claim 14, wherein the parent business data is received from at least one of:
a manufacturer, a franchisor, a distributor, a wholesaler, an enterprise, a different service provider, or a realtor.

24. The method of claim 14, wherein the content data comprises at least one of:
hypertext markup language (HTML) formatted data, extensible hypertext markup language (XHTML) formatted data, extensible markup language (XML) formatted data, dynamic hypertext markup language (DHTML) formatted data, audio data, graphic data, video data, image data, Flash, JavaScript, portable document format (PDF) data, joint photographic experts group (JPEG) data, portable networks graphic (PNG) data, tagged image file format (TIFF) data, or graphics interchange format (GIF) data.

25. The method of claim 14, wherein the web resource comprises at least one of:
a webpage, an information resource, hypertext markup language (HTML) formatted data, extensible hypertext markup language (XHTML) formatted data, extensible markup language (XML) formatted data, dynamic hypertext markup language (DHTML) formatted data, audio data, graphic data, video data, image data, Flash, JavaScript, portable document format (PDF) data, joint photographic experts group (JPEG) data, portable networks graphic (PNG) data, tagged image file format (TIFF) data, cascading style sheets (CSS) formatted data, or graphics interchange format (GIF) data.

26. The method of claim 14, further comprising creating and storing a library of content data.

27. A tangible non-transitory computer-readable storage media for storing computer-executable instructions executable by processing logic, the media storing one or more instructions for steps comprising:
receiving parent data, wherein the parent data comprises content data and parent business information;
creating a first webpage using the parent data;
transmitting the first webpage to a child;
receiving an approval response from the child;
creating a second webpage; and
transmitting the second webpage to a child distribution list.

28. The media of claim 27, further storing one or more instructions comprising:
receiving child content data; and
updating the second webpage by inserting child content data prior to transmitting the second webpage.

29. The media of claim 27, further storing one or more instructions comprising:
updating the second webpage by replacing parent business information with child business information prior to transmitting the second webpage.

30. The media of claim 27, wherein the child comprises at least one of:
a retailer, a distributor, a franchise, a customer, a service provider, a lender, or a subgroup.

31. The media of claim 27, wherein the parent business data is received from at least one of:
a manufacturer, a franchisor, a distributor, a wholesaler, an enterprise, a different service provider, or a realtor.

32. The media of claim 27, wherein business information comprises at least one of:
a business name, a postal address, an email address, a telephone number, a business logo, a uniform resource locator (URL), a Twitter account, a Linkedin account, a Facebook account, a webstore, a blog, reviews, news, social network account, social media accounts, images, comments, videos, or lead generation components.

33. The media of claim 27, wherein the child distribution list comprises at least one of:
an email address, a social network account, a Twitter account, a Facebook account, a Linkedin account, a newsfeed, a search engine, a website, or a blog.

34. A computer-implemented system for distributing advertisements, comprising:
a storage device storing parent business information and child business information; and
a processor configured to:
collect parent webpage content information;
create a first webpage based on the parent webpage content information and stored parent business information;
transmit the first webpage to a child;
process a selection from the child;
create a second webpage in response to the selection from the child, wherein the second webpage is created based on the first webpage and stored child business information; and
distribute the second webpage to a contact.
